(19) United States
(12) Patent Application Publication
(10) Pub. No.: US 2018/0040403 A1
(43) Pub. Date: Feb. 8, 2018

(54) MAGNETIC ABSORPTION STRUCTURE AND MAGNETIC BLOCKS APPLYING SUCH STRUCTURE

(71) Applicant: WIOBOY INC., BROOKLYN, NY (US)

(72) Inventor: Dan Zeng, Shenzhen (CN)

(73) Assignee: WIOBOY INC.

(21) Appl. No.: 15/292,130

(22) Filed: Oct. 13, 2016

(30) Foreign Application Priority Data
Aug. 4, 2016 (CN) 201610633120.4
Aug. 4, 2016 (CN) 201620841341.6

(51) Int. Cl. H01F 7/02

(52) U.S. Cl. CPC H01F 7/02

(57) ABSTRACT

This invention relates to a magnetic absorption structure comprising a magnetic part and a supporting part supporting the said magnetic part. The said magnetic part comprises a magnet, the said magnet comprises an absorption surface, the said absorption surface contains at least one S pole and one N pole, and the said magnetic part can rotate in relation to the said supporting part. When the magnetic absorption structures are used in pair, different polarities of the two absorption structures produce an absorption force through rotation to assure easy absorption of the two structures. At the same time, there is a short distance between the absorption surfaces, so the absorption force will be bigger when a magnet with the same intensity of magnetic force is used.

### CROSS-REFERENCE TO RELATED APPLICATIONS

This application claims priority of Chinese Patent Application No. 201610633120.4 with a filing date of Aug. 4, 2016 and Chinese Patent Application No. 201620841341.6 with a filing date of Aug. 4, 2016. The content of the aforementioned applications, including any intervening amendments thereto, are incorporated herein by reference.

### TECHNICAL FIELD

This invention relates to a magnetic absorption structure and magnetic blocks applying such structure, and particularly relates to a magnetic absorption structure characterized in the automatic adjustment of the magnetic poles and simple structure when the structures are used in pair as well as the magnetic blocks applying such structure.

### BACKGROUND OF THE PRESENT INVENTION

Magnetic absorption structures are used very widely in daily life. They are often used for apparatuses that need flexible connection to facilitate very easy combination and separation of the devices. The magnetic absorption structure characterized in the automatic adjustment of the magnetic poles can be used very conveniently, as it involves no manual adjustment of the structure. The American patent numbered U.S. Pat. No. 7,154,363B2 dated Dec. 26, 2006 discloses a magnetic connecting part (hereafter referred to as technical background 1) characterized in that a cylindrical magnet is divided into two parts along the surface passing the central axle, one part is the S pole, the other is the N pole, and the cylindrical magnet is arranged in the chamber. When two magnetic connecting parts are used in pair, the two parts of the two magnetic connecting parts that are the closest to one another are different in polarity, namely, when one side is the S pole, the other side will be the N pole. The magnetic connecting part of the structure must use a cylindrical magnet. Therefore, the outer surface of the magnet is a cambered surface When two parts move close to one another, the distance between the magnets of the two magnet connecting parts is the smallest in the middle but gradually rises upward or downward, which will lead to a decline of the absorption force as result of the unreasonable design of the structure. The American patent numbered U.S. Pat. No. 6,749,480B1 and dated Jun. 15, 2004 discloses a device that applies a magnet on a multitude of polygon structures (hereafter referred to as technical background 2). It is characterized in that different polarities are set on the two end surfaces of a cylinder to assure that when two devices absorb one another, the two end surfaces can rotate to realize an absorption connection between the devices. This structure solves the disadvantages of the American patent numbered U.S. Pat. No. 7,154,363B2. However, the structure is relatively complex and involves relatively high processing precision in order to assure smooth rotation. At the same time the complex structure itself will increase the cost and the high processing precision will further increase the cost together with the nonconformity rate and an environmental damage. Now, it is imperative to design a magnetic absorption structure characterized in the automatic adjustment of the magnetic poles and simple structure when the structures are used in pair as well as the magnetic blocks applying such structure.

### SUMMARY OF PRESENT INVENTION

The technical problem this invention aims to solve s to provide a magnetic absorption structure characterized in the automatic adjustment of the magnetic poles and simple structure when the structures are used in pair as well as the magnetic blocks applying such structure.

This invention provides a technical scheme to so e the first technical problem said above: This invention relates to a magnetic absorption structure comprising a magnetic part and a supporting part supporting the said magnetic part (10). It is characterized in that: that the said magnetic part comprises a magnet, the said magnet comprises an absorption surface, the said absorption surface contains at least one S pole and one N pole, and the said magnetic part can rotate in relation to the said supporting part.

As an improvement of this invention, the outermost profile of the said magnetic part is round.

As a further improvement of this invention, the said supporting part comprises an accommodating part accommodating the said magnetic part and the said accommodating part is a chamber.

As the second improvement of this invention, the said magnetic part comprises a rotating part and the said supporting part comprises a rotation supporting part matching the said rotating part.

As a further improvement of this invention, when the said rotating part is an axle, the said rotation supporting part will be a hole, and when the said rotating part is a hole, the said rotation supporting part will be an axle.

As an even further improvement of this invention, the said magnetic part comprises a magnetic part supporting element, and the said magnet and the said magnetic part supporting element are connected.

As the final improvement of this invention, the said supporting part comprises a magnet accommodating area, and the said magnetic is arranged in the said magnet accommodating area.

As an optimal solution, the said magnet accommodating cylindrical and the said magnet is a cylindrical magnet.

This invention provides a technical scheme to solve the second technical problem said above: A magnetic block applying the aforesaid magnetic absorption structure, which is characterized in that the the block comprises a block body, a chamber is set within the said block body, and the said magnetic absorption structure is arranged within the said chamber.

As an improvement of this invention, the the said block body consists of N panels, the said N panels enclose the said chamber, and N is a natural number.

As a further improvement of this invention, a magnetic absorption structure is set near the inner surface of at least one panel, the absorption surface of the magnetic absorption structure faces a nearby inner surface and the said supporting part is connected with the said block body.

As a further improvement of this invention, the said supporting part body comprises a supporting arm, the said rotation supporting part is set on the said supporting arm, the said supporting part base is set on a panel, and the said supporting part body is connected with the said supporting part base. The said supporting part base is provided with a coupling gap, and the said supporting part body is coupled with the said coupling gap to realize the connection with the supporting part base.

As a further improvement one of this invention, N is 6, there are six magnetic parts, a corresponding magnetic part is set near the inner surface of said every panel, the absorption surface of the magnetic part faces the inner surface of the corresponding panel, and the said supporting part comprises at one supporting part base arranged on the inner surface of the panel and one supporting part body set on the said supporting part base.

As an optimal solution, a groove is set in the position where the said supporting part body and the said coupling gap match one another, and the side wall of the said coupling gap is embedded into the said groove. A compression structure is set on the opposite panel of the panel where the supporting part base is set, and the said compression structure props against the supporting part body. There are four said coupling gaps, and every two of the four said coupling gaps are set opposite to one another.

As an optimal solution, the said supporting body comprises six supporting arms, and the ends of the aid six supporting arms face the inner surfaces of the said six panels. The said six supporting arms are connected, and the included angle is 90 degrees between every two adjacent supporting arms of the said six supporting arms. The said compression structure comprises two compression boards set in parallel, the ends of the said compression boards are provided with compression grooves and the said compression grooves props against the said supporting part body.

As a further improvement two of this invention, N is 2, the entirety of the said block body is a cone, there is one said magnetic part, and the absorption surface of the magnetic part faces the inner surface of the panel located on the bottom face.

As a further improvement three of this invention, N is 3, the said block body is a cylinder, there are two said magnetic parts, the absorption surface of one magnetic part) faces the inner surface of the panel located on the bottom face, and the absorption surface of the other magnetic part faces the inner surface of the panel on the top surface.

As a further improvement four of this invention, N is 4, there are four said magnetic parts (10), the said block body is a tetrahedron, and the absorption surface of the magnetic part near the inner surface of every panel faces the inner surface of the panel.

As a further improvement five of this invention, N is 5, there are five said magnetic parts, the said block body is a tetrahedron, and the absorption surface of the magnetic part near the inner surface of every panel faces the inner surface of the panel.

This invention can be implemented to achieve the following benefit:

This invention relates to a magnetic absorption structure comprising a magnetic part and a supporting part supporting the said magnetic part The said magnetic part comprises a magnet, the said magnet comprises an absorption surface, the said absorption surface contains at least one S pole and one N pole, and the said magnetic part can rotate in relation to the said supporting part. When a pair of magnetic absorption structure are used together and brought to one another, if the polarity of the absorption surface of one magnetic absorption structure does not remain in the position of mutual absorption with the polarity of the absorption surface of the other magnetic absorption structure, the magnetic part or parts of one or two of the magnetic absorption structures will rotate in relation to the supporting part until the S pole or N pole of the absorption surface of one magnetic absorption structure corresponds to the N pole or S pole of the absorption surface of the other magnetic absorption structure. It can be seen that when the magnetic absorption structures adopting this structure are used in pair, at least an S pole or N pole on the absorption surface of one magnetic absorption structure will create a mutual absorption with the N pole or S pole on the absorption surface of the other magnetic absorption structure to generate an absorption force. This represents a fundamental difference from the magnetic absorption structure said in technical background 2: When it works, only one polarity of one magnetic absorption structure will create a mutual absorption with one polarity of another magnetic absorption structure. Compared to technical background 2, the magnetic absorption structure said in this invention is characterized in a simple structure and easy absorption between two structures when they are used in pair. At the same time, the structure also avoids a possible damage to the magnet when the two end surfaces of the magnet in technical background 2 rotate back and fro. Also, this invention can use a thin magnet, while the polarities of the magnet are arranged on the two end surfaces of the cylindrical magnet in technical background 2. Therefore, the magnet in technical background 2 involves certain thickness requirement in order to magnetize the magnet smoothly. In contrast, this invention can use a relatively thin magnet, so it can be used for occasions that involve a significant restriction over height and space. Compared to technical background 1, given the same magnetic force requirement, the distance is roughly the same and short between the absorption surfaces of the magnets under this invention. Therefore, when the magnet with the same magnetic force is used, the magnetic absorption structures said under this invention can create a bigger absorption force when they are used in pair. For this reason, the magnet under this invention can have a smaller volume, which makes this invention possible to serve various occasions setting the least volume requirement.

The outermost profile of the said magnetic part is round. The said supporting part comprises an accommodating part accommodating the said magnetic part. The said accommodating part is a chamber. The said chamber is a cylindrical chamber. This structure can assure smooth rotation of the round magnetic part in the accommodating part, thereby assuring that when the magnetic absorption structures are used in pair, the polarity on the absorption surface of one magnetic absorption structure and that on the absorption surface of the other magnetic absorption structure can smoothly rotate to the position of mutual absorption, thereby realizing the absorption between the two magnetic absorption structures.

The said magnetic part comprises a rotating part and the said supporting part comprises a rotation supporting part matching the said rotating part. When the said rotating part is an axle, the said rotation supporting part will be a hole, and when the said rotating part is a hole, the said rotation supporting part will be an axle. The rotating part of the magnetic part and the rotation supporting part of the supporting part can match one another to assure the smooth rotation of the magnetic part in relation to the supporting part. This will further assure that when the magnetic absorption structures are used in pair, the polarity on the absorption surface of one magnetic absorption structure and that on the absorption surface of the other magnetic absorption structure can smoothly rotate to the position of mutual absorption, thereby realizing the absorption between the two magnetic absorption structures.

The said magnetic part comprises a magnetic part supporting element, and the said magnet and the said magnetic part supporting element are connected. The said supporting part comprises a magnet accommodating area, and the said magnetic is arranged in the said magnet accommodating area The said magnet accommodating area is cylindrical and the said magnet is a cylindrical magnet. The design of the magnetic part supporting element avoids directly processing the rotating part on the magnet, thereby increasing the processing cost of the magnet and making it possible to directly use magnets in general shapes for this invention, which will cut the cost. At the same time, the cylindrical magnet can rotate in the cylindrical magnet accommodating area. This will further assure that when the magnetic absorption structures are used in pair, the polarity on the absorption surface of one magnetic absorption structure and that on the absorption surface of the other magnetic absorption structure can smoothly rotate to the position of mutual absorption, thereby realizing the absorption between the two magnetic absorption structures.

A magnetic block using the aforesaid magnetic absorption structures characterized in that the the block comprises a block body, a chamber is set within the said block body, and the said magnetic absorption structure is arranged within the said chamber. The magnetic absorption structures are set in the chamber. When two blocks are brought towards one another, the polarity positions on the absorption surfaces of the magnetic absorption structures in the two block bodies will rotate, thereby assuring smooth abortion of the blocks. Compared to technical background 2, the structure under this invention is more reasonable and realizes smoother adjustment of polarities and simpler structure, which will not increase the processing difficulty while assuring smooth adjutant of polarities. This will not only reduce the chance of nonconforming products but also cut down the production cost. The the said block body consists of N panels, the said N panels enclose the said chamber, and N is a natural number. A magnetic absorption structure is set near the inner surface of at least one panel, the absorption surface of the magnetic absorption structure faces a nearby inner surface. This structure can set corresponding number of magnetic absorption structures based on concrete demand, thereby satisfying the need to use magnetic blocks. The said supporting part is connected with the said block body. The said supporting part comprises at least one supporting part base arranged on the inner surface of the panel and one supporting part body set on the said supporting part base. The said supporting part body comprises a supporting arm, and the said rotation supporting part is set on the said supporting arm. The said supporting part base is set on a panel, and the said supporting part body is connected with the said supporting part base. The said supporting part base is provided with a coupling gap, and the said supporting part body is coupled with the said coupling gap to realize the connection with the supporting part base. This structure will facilitate processing and installation.

N is 6, there are six magnetic parts, a corresponding magnetic part is set near the inner surface of said every panel, the absorption surface of the magnetic part faces the inner surface of the corresponding panel, and the said supporting part comprises at one supporting part base arranged on the inner surface of the panel and one supporting part body set on the said supporting part base. A groove is set in the position where the said supporting part body and the said coupling gap match one another, and the side wall of the said coupling gap is embedded into the said groove. A compression structure is set on the opposite panel of the panel where the supporting part base is set, and the said compression structure props against the supporting part body. There are four said coupling gaps, and every two of the four said coupling gaps are set opposite to one another. The said supporting body comprises six supporting arms, and the ends of the said six supporting arms face the inner surfaces of the said six panels. The said six supporting arms are connected, and the included angle is 90 degrees between every two adjacent supporting arms of the said six supporting arms. The said compression structure comprises two compression boards set in parallel, the ends of the said compression boards are provided with compression grooves, and the said compression grooves props against the said supporting part body. This hexahedron block assures that when it is used together with another magnetic block setting a magnetic absorption structure, the polarity on the absorption surface of any magnetic part on any surface will automatically adjust. At the same time, this structure will facilitate processing and assembly. When magnets are installed into the accommodating part, the positions of all magnets can be automatically adjusted through the absorption force or repulsive force, and the generated absorption force will assure that the magnets installed into the accommodating part will not easily drop out and also assure that the magnetic part will not easily shed when it is assembled with the supporting part. At assembly, the supporting part can be further assembled with assembled parts, and then directly put in the chamber. This structural design also increases the assembly efficiency.

N is 2, the entirety of the said block body is a cone, there is one said magnetic part, and the absorption surface of the magnetic part faces the inner surface of the panel located on the bottom face, N is 3, the said block body is a cylinder there are two said magnetic parts, the absorption surface of one magnetic part) faces the inner surface of the panel located on the bottom face, and the absorption surface of the other magnetic part faces the inner surface of the panel on the top surface. N is 4, there are four said magnetic parts (10), the said block body is a tetrahedron, and the absorption surface of the magnetic part near the inner surface of every panel faces the inner surface of the panel. N is 5, there are five said magnetic parts, the said block body is a tetrahedron, and the absorption surface of the magnetic part near the inner surface of every parcel faces the inner surface of the panel. When N is 1, the said block body is sphere or any other shape consisting of cambered surfaces. This will assure that during actual use, the value of N can be determined based on concrete demand to satisfy the use of magnetic blocks.

### DESCRIPTION OF THE DRAWINGS

Next, this invention will be further described in greater detail with the attached drawings In particular:

FIG. 1 is a schematic diagram of the magnet whose absorption surfaces are two poles;

FIG. 2 is a schematic diagram of the magnet whose absorption surfaces are four poles;

FIG. 3 is a schematic diagram of the magnet whose absorption surfaces are eight poles;

FIG. 4 is a structural schematic diagram for the first magnetic absorption structure said under this invention;

FIG. 5 is a structural schematic diagram for the first magnetic absorption structure without the magnetic part said under this invention;

FIG. 6 is a structural schematic diagram for the second magnetic absorption structure said under this invention;

FIG. 7 is a structural schematic diagram for the second magnetic absorption structure without the magnetic part said under this invention;

FIG. 8 is a structural schematic diagram or the third magnetic absorption structure said under this invention;

FIG. 9 is a schematic diagram for the third magnetic absorption structure said under this invention when they are used in pair;

FIG. 10 is a structural schematic diagram for the fourth magnetic absorption structure said under this invention;

FIG. 11 is a schematic diagram for the fourth magnetic absorption structure said under this invention when they are used impair;

FIG. 12 is a breakdown schematic diagram for the magnet and the magnetic part supporting element said under this invention;

FIG. 13 is a local structural schematic diagram for the first magnetic block said under this invention;

FIG. 14 is a breakdown structural schematic diagram for the second magnetic block said under this invention;

FIG. 15 is a breakdown structural schematic diagram for the second magnetic block without the block body said under this invention;

FIG. 16 is a local structural schematic diagram for the block body of the second magnetic block said under this invention;

FIG. 17 is a structural schematic diagram for the panel of the second magnetic block set with a compression board said under this invention;

FIG. 18 is a structural schematic diagram for the assembly between the magnetic absorption structure of the second magnetic block and the panel set with a compression board said under this invention;

FIG. 19 is a structural schematic diagram for the second magnetic block without the block body said under this invention;

FIG. 20 is a breakdown structural schematic diagram for the third magnetic block said under this invention;

FIG. 21 is a breakdown structural schematic diagram for the fourth magnetic block said under this invention;

FIG. 22 is a breakdown structural schematic diagram when the block body of the magnetic block said under this invention is a cone;

FIG. 23 is a breakdown structural schematic diagram when the block body of the magnetic block said under this invention is a cylinder;

FIG. 24 is a breakdown structural schematic diagram when the block body of the magnetic block said under this invention is a pentahedron;

### DETAILED DESCRIPTION OF PREFERRED EMBODIMENTS

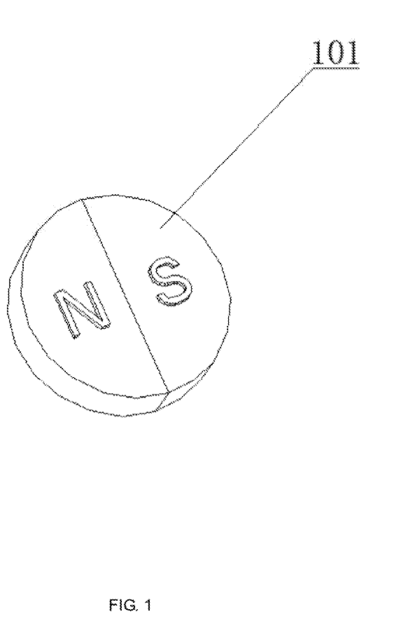

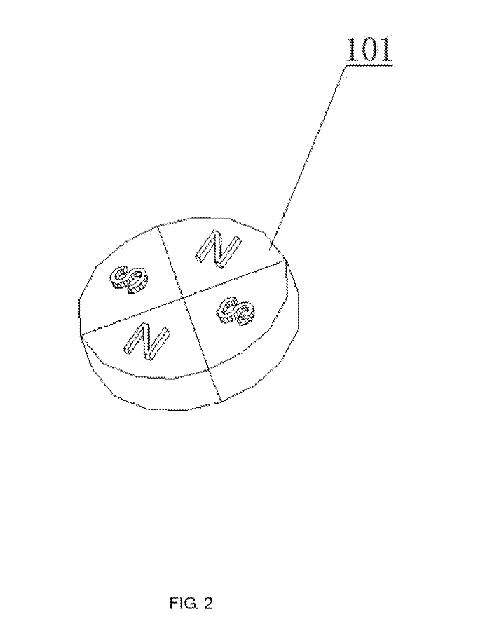

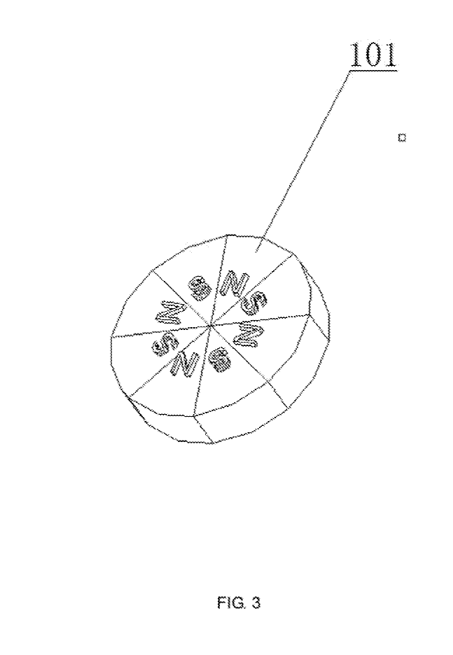

As shown in FIG. 1, the absorption surface of the magnet 101 comprises an S pole and an N pole, which occupy half of the absorption surface respectively. As shown in FIG. 2, the absorption surface of the magnet 101 comprises two S poles and two N poles. Every S pole occupies a quarter of the absorption surface, and every N pole also occupies a quarter of the absorption surface. As shown in FIG. 3, the absorption surface of the magnet 101 comprises four S poles and four N poles. Every S pole occupies one eighth of the absorption surface, and every N pole also occupies one eighth of the absorption surface.

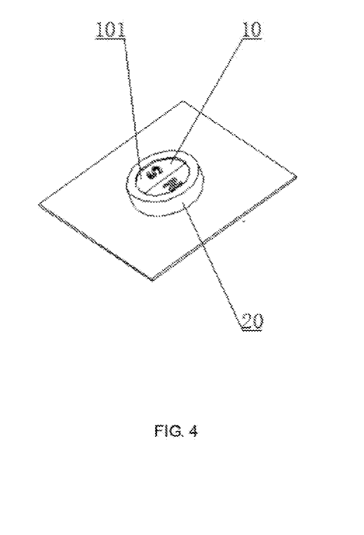

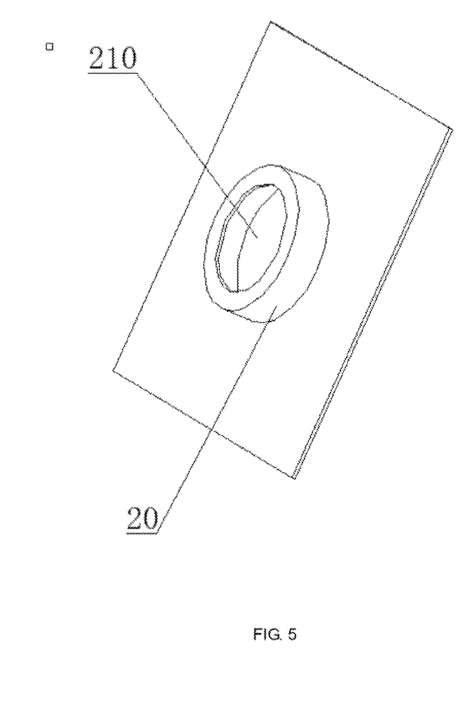

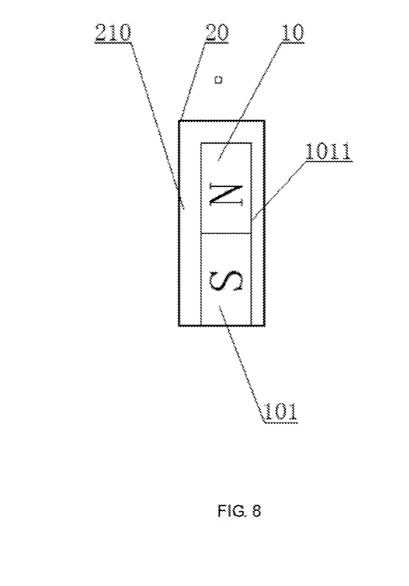

As shown in FIGS. 4, 5 and 8, a magnetic absorption structure comprises a magnetic part 10 and a supporting part 20 supporting the said magnetic part 10, the said magnetic part 10 comprises a magnet 101, the said magnet 101 comprises an absorption surface 1011, the said absorption surface 1011 contains at least one S pole and one N pole, and the said magnetic part 10 can rotate in relation to the said supporting part 20. The outermost profile of the said magnetic part 10 is round. The said supporting part 20 comprises an accommodating part 210 accommodating the said magnetic part 10. The said accommodating part 210 is a chamber, the said chamber can be in any shape, and this implementation instance selects a cylindrical chamber as the optimal solution.

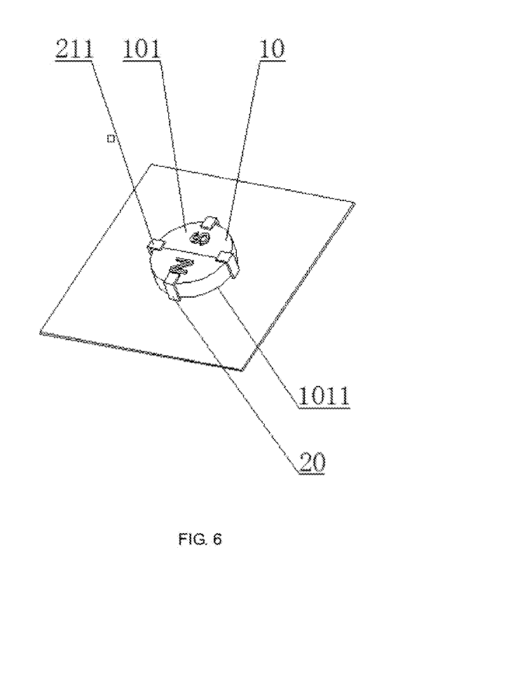

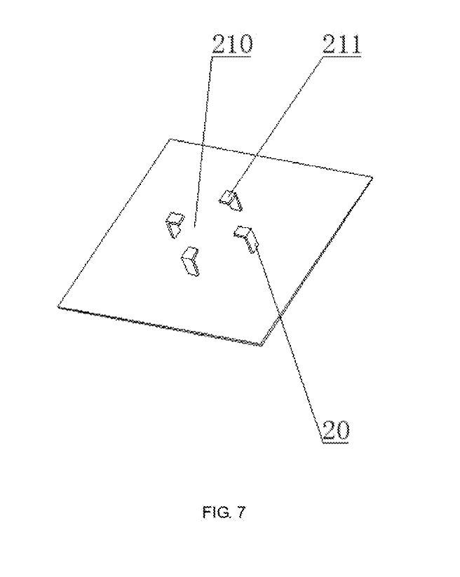

As shown in FIGS. 6 and 7, a magnetic absorption structure comprises a magnetic part 10 and a supporting part 20 supporting the said magnetic part 10, the said magnetic part 10 comprises a magnet 101, the said magnet 101 comprises an absorption surface 1011, the said absorption surface 1011 contains at least one S pole and one N pole, and the said magnetic part 10 can rotate in relation to the said supporting part 20. The outermost profile of the said magnetic part 10 can be in any shape, and this implementation instance selects a round as the optimal solution. The said supporting part 20 comprises an accommodating part 210 accommodating the said magnetic part 10. The said accommodating part 210 is a space formed by a multitude of limiting elements 211.

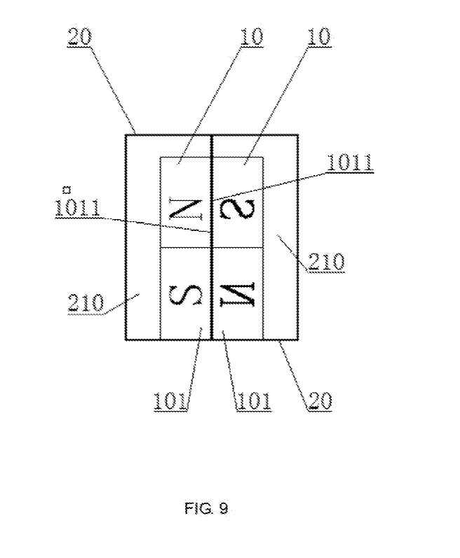

As shown in FIG. 9, when two magnetic absorption structure are brought to one another, the polarity on the absorption surface of one magnetic absorption structure and the polarity on the absorption surface of the magnetic absorption structure can smoothly rotate to the position to absorb one another, that is, the S pole or N pole of the absorption surface of one magnetic absorption structure corresponds to the N pole or S pole of the absorption surface of the other magnetic absorption structure. When there are a multitude of polarities on the absorption surface of the magnetic absorption structure, such correspondence will exist as well.

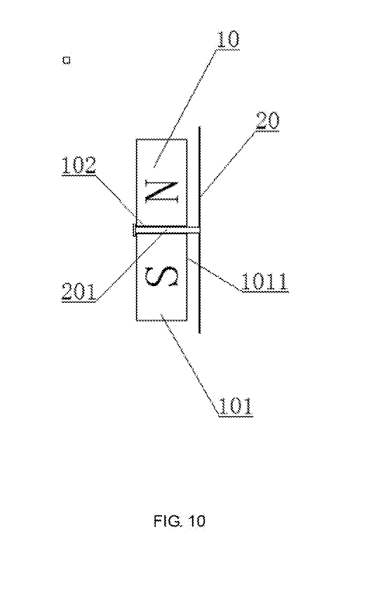

As shown in FIG. 10, a magnetic absorption structure comprises a magnetic part 10 and a supporting part 20 supporting the said magnetic part 10, the said magnetic part 10 comprises a magnet 101, the said magnet 101 comprises an absorption surface 1011, the said absorption surface 1011 contains at least one S pole and one N pole, and the said magnetic part 10 can rotate in relation to the said supporting part 20. The said magnetic part 10 comprises a rotating part 102 and the said supporting part 20 comprises a rotation supporting part 201 matching the said rotating part 102. When the said rotating part 102 is a hole, the said rotation supporting part 201 will be an axle.

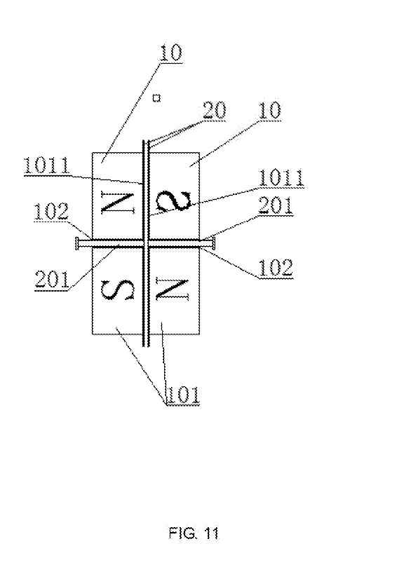

As shown in FIG. 11, when two magnetic absorption structure are brought to one another, the polarity on the absorption surface of one magnetic absorption structure and the polarity on the absorption surface of the magnetic absorption structure can smoothly rotate to the position to absorb one another, that is, the S pole or N pole of the absorption surface of one magnetic absorption structure corresponds to the N pole or S pole of the absorption surface of the other magnetic absorption structure. When there are a multitude of polarities on the absorption surface of the magnetic absorption structure, such correspondence will exist as well.

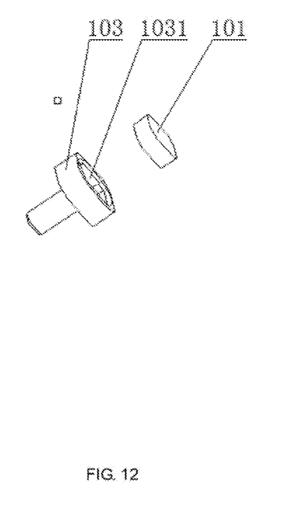

As shown in FIG. 12, the said magnetic part 10 comprises a magnetic part supporting element 103, and the said magnet 101 and the said magnetic part supporting element 103 are connected. The said supporting part 103 comprises a magnet accommodating area 1031, and the said magnetic 103 is arranged in the said magnet accommodating area 1031. The said magnet accommodating area 1031 is cylindrical and the said magnet 101 is a cylindrical magnet.

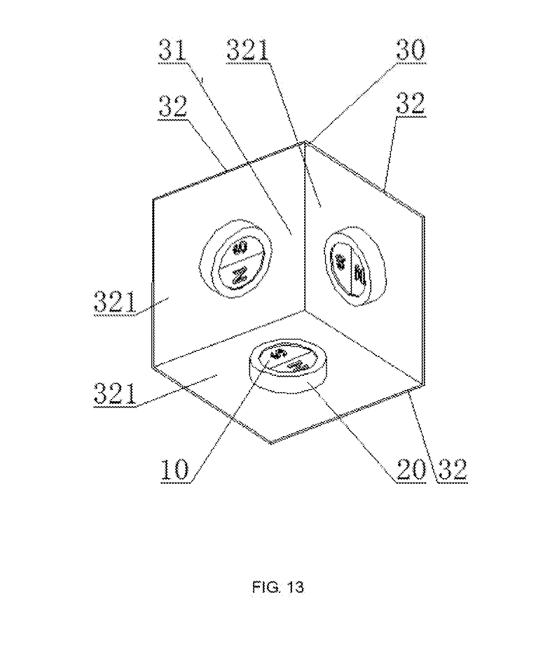

As shown in FIG. 13, a magnetic block comprises a block body 30, a chamber 31 is set within the said block body 30, and the said magnetic absorption structure is arranged within the said chamber 31. The said block body 30 consists of 6 panels 32, the said 6 panels 32 enclose the said chamber 31. At least one magnetic absorption structure is set near the inner surface of at least one panel 32, and the absorption surface of the magnetic absorption structure faces the inner surface of a nearby panel 32.

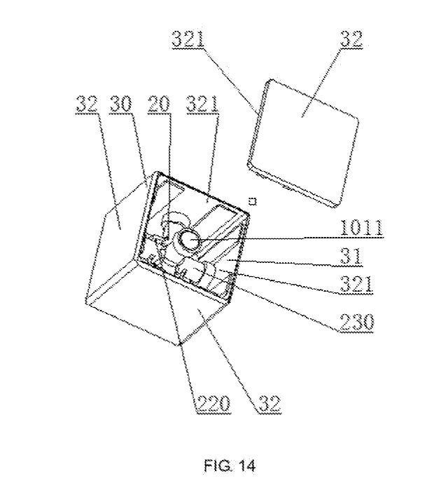

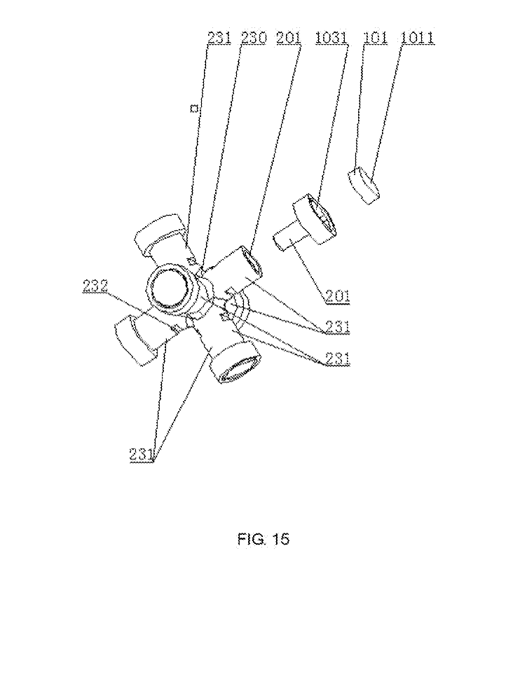

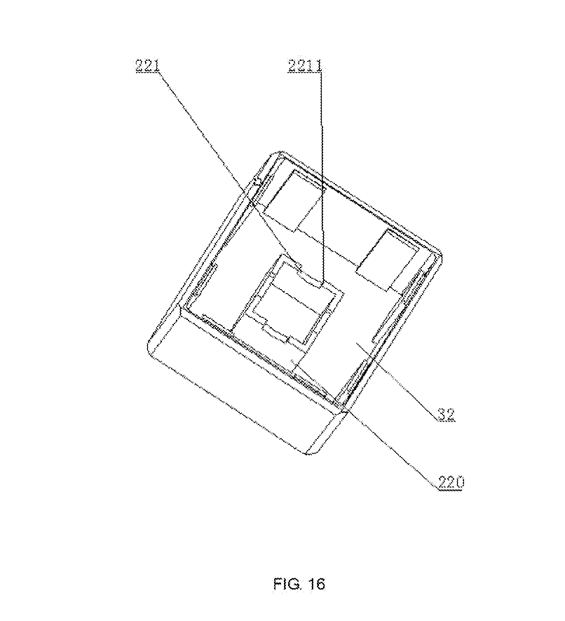

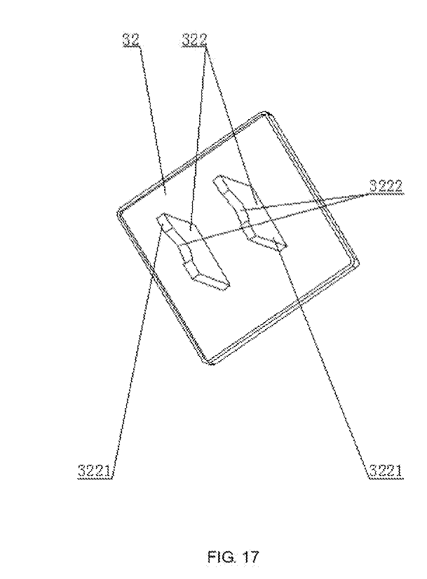

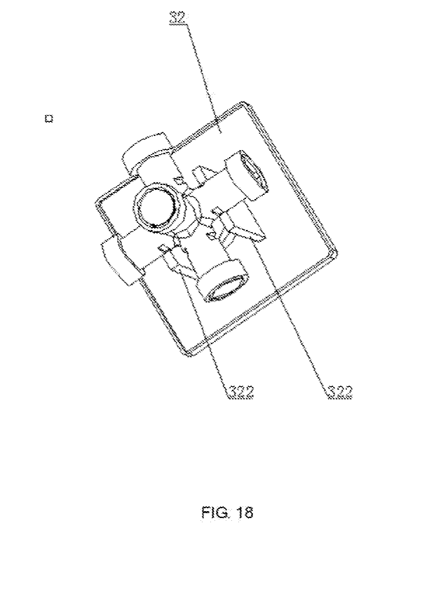

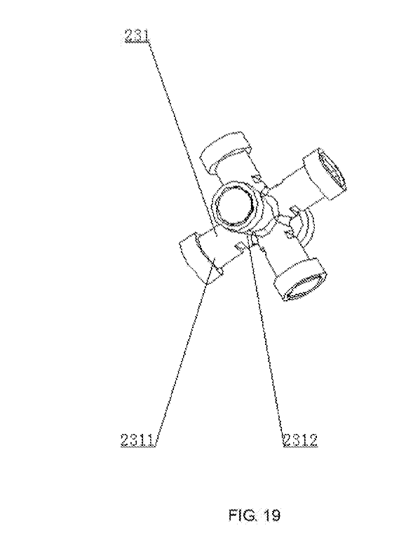

As shown in FIGS. 14-19, a magnetic block comprises a block body 30, a chamber 31 is set within the said block body 30, and the said magnetic absorption structure is arranged within the said chamber 31. The said block body 30 consists of 6 panels 32, the said 6 panels 32 enclose the said chamber 31. At least one magnetic absorption structure is set near the inner surface of at least one panel 32, and the absorption surface 1011 of the magnetic absorption structure faces the inner surface of a nearby panel 32. The said supporting part 20 is connected with the said block body 30. The said supporting part 20 comprises one supporting part base 220 arranged on the inner surface of the panel 32 and one supporting part body 230 set on the said supporting part base 220. The said supporting part body 230 comprises a supporting arm 231, and the said rotation supporting part 201 is set on the said supporting arm 231. The said supporting part base 220 is set on a panel 32, and the said supporting part body 230 is connected with the said supporting part base 220. The said supporting part base 220 is provided with a coupling gap 221, and the said supporting part body 230 is coupled with the said coupling gap 221 to realize the connection with the supporting part base 220. A magnetic block said according to Claim 14 is characterized in that N is 6 there are six magnetic parts (10), a corresponding magnetic part (10) is set near the inner surface of said every panel (32), the absorption surface (1011) of the magnetic part (10) faces the inner surface of the corresponding panel (32), and the said supporting part (20) comprises at one supporting part base (220) arranged on the inner surface of the panel (32) and one supporting part body (230) set on the said supporting part base (220). A groove 232 is set in the position where the said supporting part body 230 and the said coupling gap 221 match one another, and the side wall 2211 of the said coupling gap 221 is embedded into the said groove 232. A compression structure 322 is set on the opposite panel 32 of the panel 32 where the supporting part base 220 is set, and the said compression structure 322 props against the supporting part body 230. There are four said coupling gaps 221, and every two of the four said coupling gaps 221 are set opposite to one another. The said supporting body 230 comprises six supporting arms 231, and the ends of the said six supporting arms 231 face the inner surfaces of the said six panels 32. A magnetic block said according to Claim 19 is characterized in that the starting ends 2312 of the said six supporting arms 231 are connected, and the included angle is 90 degrees between every two adjacent supporting arms 231 of the said six supporting arms 231. The said compression structure 322 comprises two compression boards 3221 set in parallel, the ends of the said compression boards 3221 are provided with compression grooves 3222, and the said compression grooves 3222 props against the said supporting part body 230

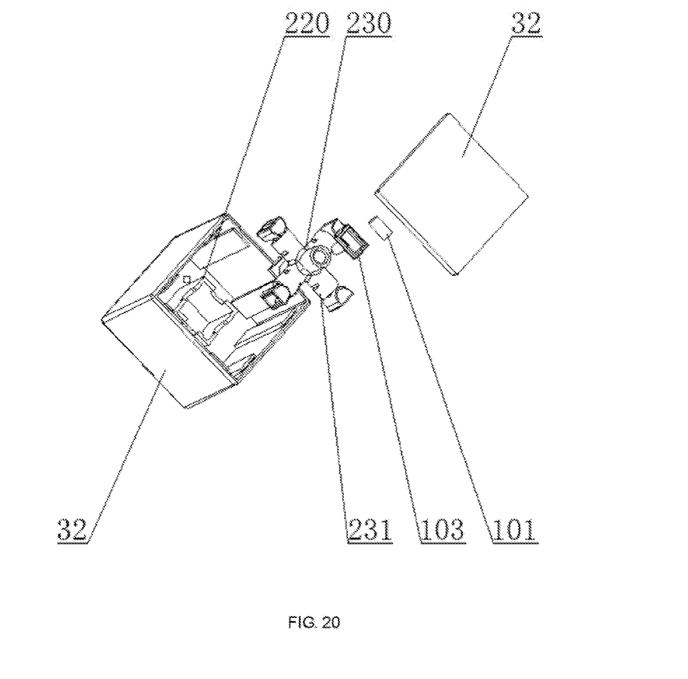

As shown in FIG. 20, the magnetic block illustrated in FIG. 20 is different from that shown in FIG. 14 only in that the absorption surface 1011 of the magnet 101 of the magnetic absorption structure of the magnetic block shown in FIG. 14 is the end surfaces of the cylindrical magnet, that is, the end surfaces are provided with an S pole and an N pole simultaneously. In contrast, the absorption surface of the magnetic absorption structure 101 shown in FIG. 20 is the lateral sides of the cylindrical magnet. That is, the side surfaces of the magnet 101 as the absorption surface are provided with the S pole and the N pole simultaneously.

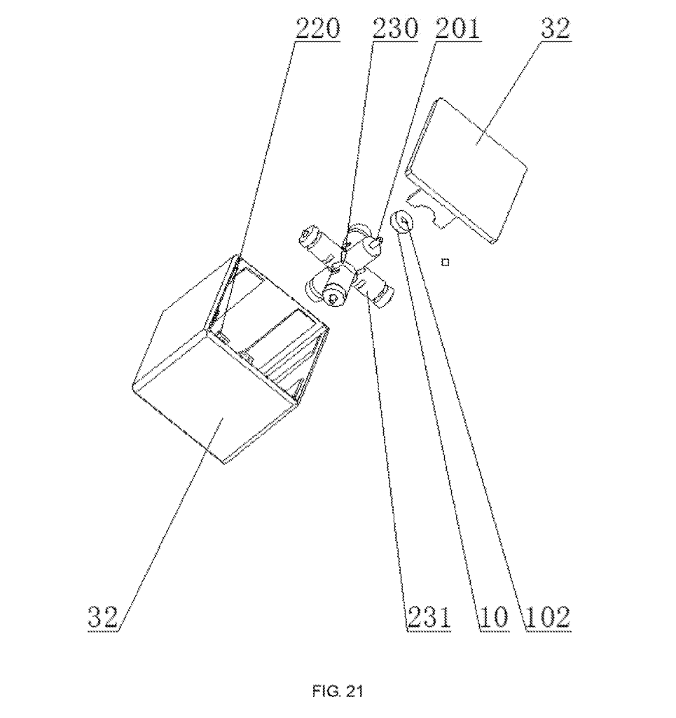

As shown in FIG. 21, the magnetic block illustrated in FIG. 20 is different from that shown in FIG. 14 only in that the magnetic part 10 of the magnetic absorption structure of the magnetic block shown in FIG. 20 is the magnet 101 itself, thereby saving the magnetic part supporting element 103, the magnet 101 itself has a hole, which is just the rotating part 102, the supporting arm 231 is provided with an axle matching the rotating part 102, and the axle is simply the rotation supporting part 201.

When M is 1, the entirety of the said block body 30 is a sphere, there is one or a multitude of the said magnetic part or parts (10) based on the need, and the absorption surface of these magnetic parts 10 is oriented towards the inner surface of the sphere.

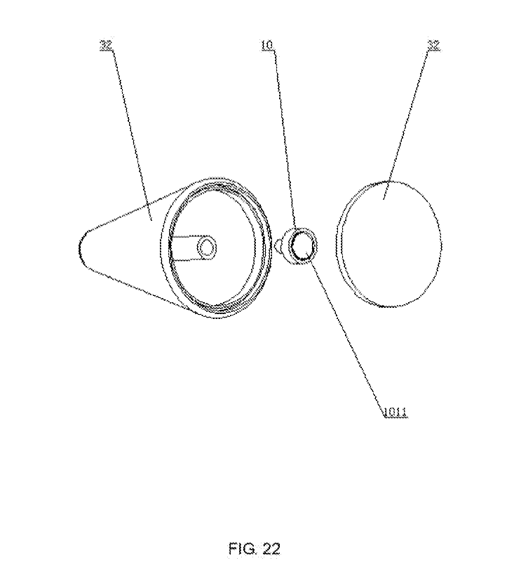

As shown in FIG. 22, when M is 2, the entirety of the said block body 30 is a cone, there is one said magnetic part 10, and the absorption surface of the magnetic part 10 faces the inner surface of the panel 32 located on the bottom face.

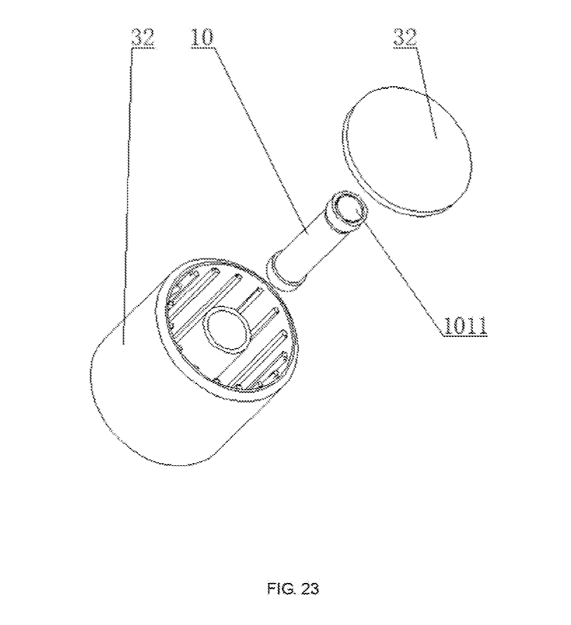

As shown in FIG. 23, when M is 3, the said block body 30 is a cylinder, there are two said magnetic parts 10, the absorption surface of one magnetic part 10 faces the inner surface of the panel 32 located on the bottom face, and the absorption surface 1011 of the other magnetic part 10 faces the inner surface of the panel 32 on the top surface.

When M is 4, there are four said magnetic parts 10, the said block body is a tetrahedron, and the absorption surface of the magnetic part near the inner surface of every panel faces the inner surface of the panel.

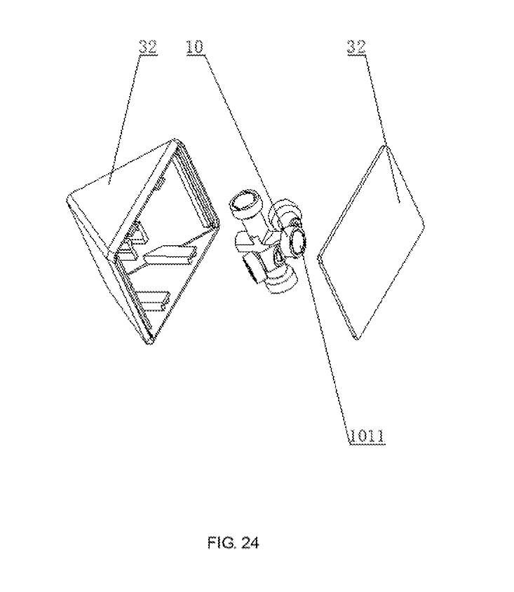

As shown in FIG. 24, when M is 5, there are five said magnetic parts 10, the said block body is a pentahedron, and the absorption surface 1011 of the magnetic part 10 near the inner surface of every panel 32 faces the inner surface of the panel 32.

It must be pointed out that the implementation instances said above are only a multitude of nonrestrictive descriptions of this invention. However, technical staff in this area will understand that this invention can be modified, replaced or changed without deviating from the purpose and scope of this invention, and such modification, replacement and change shall still fall into the protection scope of this invention.

I claim:

1. A magnetic absorption structure comprising a magnetic part (10) and a supporting part (20) supporting the magnetic part (10), wherein the said magnetic part (10) comprises a magnet (101), the magnet (101) comprises an absorption surface (1011), the absorption surface (1011) contains at least one S pole and one N pole, and when in operation the magnetic part (10) rotates in relation to the supporting part (20).

2. The magnetic absorption structure according to claim 1, wherein the outermost profile of the magnetic part (10) is round, the supporting part (20) comprises an accommodating part (210) accommodating the magnetic part (10), and the accommodating part (210) is a chamber.

3. The magnetic absorption structure according to claim 1, wherein the magnetic part (10) comprises a rotating part (102) and the supporting part (20) comprises a rotation supporting part (201) matching the rotating part (102).

4. The magnetic absorption structure according to claim 3, wherein when the rotating part (102) is an axle, the rotation supporting part (201) is a hole, and when the rotating part (102) is a hole, the rotation supporting part (201) is an axle.

5. The magnetic absorption structure according to claim 4, wherein the magnetic part (10) further comprises a magnetic part supporting element (103), and the magnet (101) is connected to the magnetic part supporting element (103).

6. The magnetic absorption structure according to claim 5, wherein the magnetic part supporting element (103) comprises a magnet accommodating area (1031), and the magnet (101) is set within the magnet accommodating area (1031).

7. The magnetic absorption structure according to claim 6, wherein the magnet accommodating area is cylindrical and the magnet (101) is a cylindrical magnet.

8. The magnetic block using the magnetic absorption structure according to claim 6, wherein the magnetic block comprises a block body (30), a chamber (31) is set within the block body (30), and the magnetic absorption structure is arranged within the chamber (31).

9. The magnetic block according to claim 8, wherein the block body (30) consists of N panels (32), the N panels enclose the chamber (31), and N is a natural number.

0. The magnetic block according to claim 9, wherein the magnetic absorption structure is set near the inner surface of the at least one N panel (32), and the absorption surface of the magnetic absorption structure faces a nearby inner surface (321).

11. The magnetic block according to claim 10, wherein the supporting part (20) is connected to the block body.

12. The magnetic block according to claim 11, wherein the supporting part (20) comprises at least one supporting part base (220) arranged on the inner surface of the panel (32) and one supporting part body (230) set on the supporting part base (220).

13. The magnetic block according to claim 12, wherein the supporting part body (230) comprises a supporting arm (231), the rotation supporting part (201) is set on the supporting arm (231), the supporting part base (220) is set on the panel (32), and the supporting part body (230) is connected to the supporting part base (220).

14. The magnetic block according to claim 13, wherein the supporting part base (220) is provided with a coupling gap (221), and the supporting part body (230) is coupled with the coupling gap (221) to realize the connection to the supporting part base (220).

15. The magnetic block according to claim 14, wherein N is 6, there are six magnetic parts (10), a magnetic part (10) is set near the inner surface of each panel (32), the absorption surface (1011) of the magnetic part (10) faces the inner surface of the respective panel (32), and the supporting part (20) comprises one supporting part base (220) arranged on the inner surface of the panel (32) and one supporting part body (230) set on the supporting part base (220).

16. The magnetic block according to claim 15, wherein a groove (232) is set in the position where the supporting part body (230) and the coupling gap (221) match one another, and the side wall (2211) of the coupling gap (221) is embedded into the groove (232).

17. The magnetic block according to claim 16, wherein a compression structure (322) is set on the opposite panel (32) of the panel (32) where the supporting part base (220) is set, and the compression structure (322) props against the supporting part body (230).

18. The magnetic block according to claim 17, wherein there are four coupling gaps (221), and every two of the four coupling gaps (221) are set opposite to one another.

19. The magnetic block according to claim 18, wherein the supporting body (230) comprises six supporting arms (231), and the ends (2311) of the six supporting arms (231) face the inner surfaces of the six panels (32).

20. The magnetic block according to claim 19, wherein the starting ends (2312) of the six supporting arms (231) are connected, and the included angle is 90 degrees between every two adjacent supporting arms (231) of the six supporting arms (231).

21. The magnetic block according to claim 20, wherein the compression structure (322) comprises two compression boards (3221) set in parallel, the ends of the compression boards (3221) are provided with compression grooves (3222), and the compression grooves (3222) prop against the supporting part body (230).

22. The magnetic block according to claim 14, wherein N is 2, the entirety of the block body (30) is a cone, there is one magnetic part (10), and the absorption surface of the magnetic part (10) faces the inner surface of the panel (32) located on the bottom face

14. The magnetic block according to claim 14, wherein N is 3, the block body (30) is a cylinder, there are two magnetic parts (10), the absorption surface of one magnetic part (10) faces the inner surface of the panel (32) located on the bottom face, and the absorption (1011) of the other magnetic part (10) faces the inner surface of the panel (32) on the top surface.

24. The magnetic block according to claim 14, wherein N is 4, there are four magnetic parts (10), the block body is a tetrahedron, and the absorption surface of the magnetic part near the inner surface of every panel faces the inner surface of the panel.

25. The magnetic block according to claim 14, wherein N is 5, there are five magnetic parts (10), the block body is a pentahedron, and the absorption surface (1011) of the magnetic part (10) near the inner surface of every panel (32) faces the inner surface of the panel (32).
